(19) United States
(12) Patent Application Publication
(10) Pub. No.: US 2017/0237503 A1
(43) Pub. Date: Aug. 17, 2017

(54) Distance Measurement Method, Device and System

(71) Applicant: ZTE Corporation, Shenzhen (CN)

(72) Inventors: Dan GENG, Shenzhen (CN); Weiliang ZHANG, Shenzhen (CN); Dezhi ZHANG, Shenzhen (CN)

(21) Appl. No.: 15/502,277

(22) PCT Filed: Jun. 8, 2015
(86) PCT No.: PCT/CN2015/080998

§ 371 Date: Feb. 7, 2017

(30) Foreign Application Priority Data
Aug. 7, 2014 (CN) 201410387584.2

(51) Int. Cl. H04B 10/572; H04J 14/02

(52) U.S. Cl. CPC H04B 10/572; H04J 14/0249

(57) ABSTRACT

Provided are a distance measurement method, device and system. In the method, an Optical Line Terminal (OLT) commands an Optical Network Unit (ONU) to perform wavelength tuning; and when a message indicating that the wavelength tuning is completed is received from the ONU, the OLT measures a distance to the ONU.

### TECHNICAL FIELD

The present disclosure relates to the field of communication, and particularly to a distance measurement method, device and system.

### BACKGROUND

Along with development of network technologies, massive services such as voice, data and video can be transmitted by virtue of a network, which continuously increases the requirement on network bandwidth. A Passive Optical Network (PON) is generated under such a requirement. The topological structure of a PON system is shown in FIG. 1. As shown in FIG. 1, the PON system usually consists of an Optical Line Terminal (OLT) on an office side, and an Optical Distribution Network (ODN) and an Optical Network Unit (ONU) on a user side. The PON system usually adopts a network structure of one-to-many. The ODN consists of passive optical devices such as a single-mode optical fiber, an optical splitter and an optical connector. The ODN provides an optical transmission medium for a physical connection between the OLT and the ONU. In order to further increase the bandwidth of the network, transmission is implemented through multiple wavelengths in a trunk optical fiber in a current PON technology, and such a system is called a Time Wavelength Division Multiplexing (TWDM) PON system.

The topological structure of a TWDM PON system is shown in FIG. 2. There are multiple TWDM channels in the TWDM system. There may be a channel terminal of one OLT and a group of corresponding ONUs on each TWDM channel. Each TWDM channel includes one downstream wavelength channel and one or more upstream wavelength channels. Each TWDM channel terminal manages a group of ONUs. The group of ONUs is configured to send upstream data with the same upstream wavelength and receive downstream data with the same downstream wavelength. Different ONUs in a group of ONUs transmit upstream data in a time division multiplexing manner. Downstream wavelengths of different TWDM channels are different. Upstream wavelengths used by the group of ONUs managed by the channel terminals of different OLTs are also different. Each ONU sends upstream data in a specific upstream timeslot according to commands of the TWDM channel terminals.

In order to implement load balancing, energy saving, protection switching, ONU inventory type reduction and the like, ONUs in a TWDM PON system are colorless, which means that transmitters and receivers of all the ONUs are the same. The sending wavelengths and receiving wavelengths of ONUs are tunable. An OLT may command an ONU to tune a working wavelength of the ONU, so that the ONU may work in any TWDM channel. After the OLT commands the ONU to change the TWDM channel, the ONU also changes an upstream wavelength for data sending and a downstream wavelength for data receiving. After the ONU changes the wavelength channel, a different upstream wavelength is adopted to send upstream data, and a path of an optical fiber for data transmission from the ONU to the OLT changes, which may cause a change in the length of the optical fiber for data transmission from the ONU to the OLT. For such a reason, a loop delay between the ONU and the OLT may change. As a result, the OLT needs to measure the distance to the ONU again, and send a new distance measurement result to the ONU so that the ONU can implement the synchronization of upstream transmission with other ONUs working on the current TWDM channel. The ONU needs to perform a registration and activation process again before the OLT can measure the distance to the ONU, thereby increasing complexity in system implementation and causing service interruption of the ONU and influence on quality of service of a PON.

For the problems of increase of complexity in system implementation, service interruption of an ONU and influence on quality of service of a PON due to change of the wavelength channel of the ONU in a related technology, there is yet no effective solution disclosed at present.

### SUMMARY

For the problems of increase of complexity in system implementation, service interruption of an ONU and influence on quality of service of a PON due to change of the wavelength channel of the ONU in the related technology, embodiments of the present disclosure provide a distance measurement method, device and system, so as to at least solve the abovementioned problems.

According to an aspect of the embodiments of the present disclosure, a distance measurement method is provided, which may include that: an OLT commands an ONU to perform wavelength tuning; and when a message indicating that the wavelength tuning is completed is received from the ONU, the OLT measures a distance to the ONU.

Optionally, after the step that the OLT commands the ONU to perform the wavelength tuning, the method may include that: the OLT allocates, to the ONU, an upstream bandwidth used for sending the message indicating that the wavelength tuning is completed; and after the wavelength tuning is completed, the ONU sends, within the upstream bandwidth, the message indicating that the wavelength tuning is completed.

Optionally, after the step that the OLT measures the distance to the ONU, the method may further include that: the OLT sends a confirmation message to the ONU, wherein information carried in the confirmation message may include: confirmation information confirming that the ONU completes the wavelength tuning, and indication information about a distance measurement result obtained by measuring the distance to the ONU.

Optionally, the indication information about the distance measurement result may be indication information about equalization delay adjustment of the ONU.

Optionally, the indication information about the equalization delay adjustment of the ONU may include at least one of followings: a new equalization delay value, a difference value between a new equalization delay value and a current equalization delay value of the ONU, and indication information indicating an equalization delay of the ONU not to be adjusted.

According to another aspect of the embodiments of the present disclosure, a distance measurement device is provided, which may include: a commanding module, arranged to command, through an OLT, an ONU to perform wavelength tuning; and a distance measurement module, arranged to, when the OLT receives a message indicating that the wavelength tuning is completed from the ONU, measure a distance to the ONU.

Optionally, the device may further include: an allocation module, arranged to allocate, to the ONU, an upstream bandwidth used for sending the message indicating that the wavelength tuning is completed; and a receiving module, arranged to receive, within the upstream bandwidth, the message indicating that the wavelength tuning is completed from the ONU.

Optionally, the device may further include: a sending module, arranged to send a confirmation message to the ONU, wherein information carried in the confirmation message may include: confirmation information confirming that the ONU completes the wavelength tuning, and indication information about a distance measurement result obtained by measuring the distance to the ONU.

According to another aspect of the embodiments of the present disclosure, an OLT is provided, which may include the abovementioned distance measurement device.

According to another aspect of the embodiments of the present disclosure, a distance measurement system is provided, which may include: an ONU and the abovementioned OLT, wherein the ONU may be arranged to, when a wavelength tuning command is received from the OLT, perform wavelength tuning according to the wavelength tuning command, and when the wavelength tuning is completed, send a message indicating that the wavelength tuning is completed to the OLT.

By the method of measuring the distance to the ONU at the same time when the OLT receives the message indicating that the wavelength tuning is completed from the ONU in the embodiment of the present disclosure, time required by service recovery after wavelength tuning of the whole PON system may be reduced. The problems of system complexity and service interruption caused by additional steps required by distance re-measurement are solved. The complexity in a requirement of wavelength tuning of the ONU in the TWDM PON system on distance re-measurement is reduced, upstream transmission efficiency is improved, and quality of service of a network is improved.

### BRIEF DESCRIPTION OF THE DRAWINGS

The drawings described here are adopted to provide further understanding of the present disclosure, and form a part of the present disclosure. Schematic embodiments of the present disclosure and descriptions thereof are adopted to explain the present disclosure and not intended to form improper limits to the present disclosure. In the drawings:

FIG. 1 is a schematic diagram of a topological structure of a PON system according to the related technology;

FIG. 2 is a schematic diagram of a topological structure of a TWDM PON system according to the related technology;

FIG. 3 is a structure diagram of a distance measurement system according to an embodiment of the present disclosure;

FIG. 4 is a structure diagram of a distance measurement device according to an embodiment of the present disclosure; and

FIG. 5 is a flowchart of a distance measurement method according to an embodiment of the present disclosure.

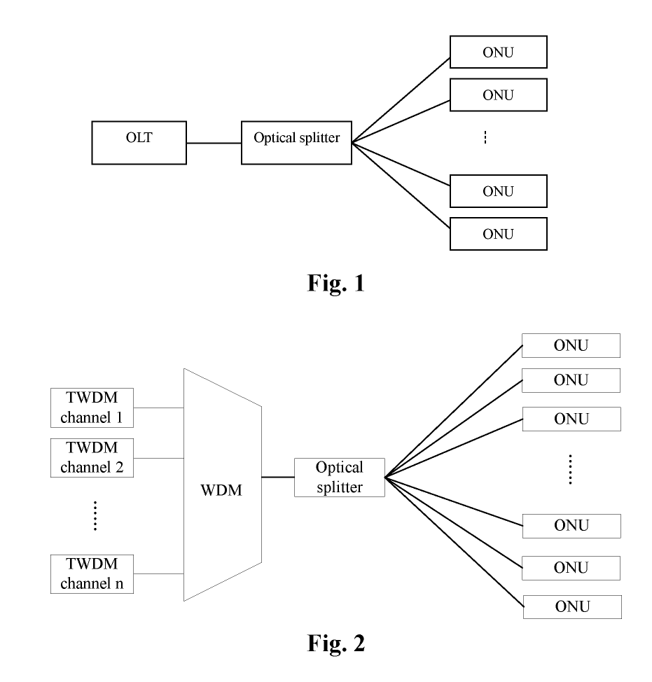

### DETAILED DESCRIPTION OF THE EMBODIMENTS

The present disclosure will be described below with reference to the drawings and embodiments in detail. It is important to note that the embodiments in the present disclosure and characteristics in the embodiments may be freely combined under the condition of no conflicts.

According to an embodiment of the present disclosure, a distance measurement system is provided.

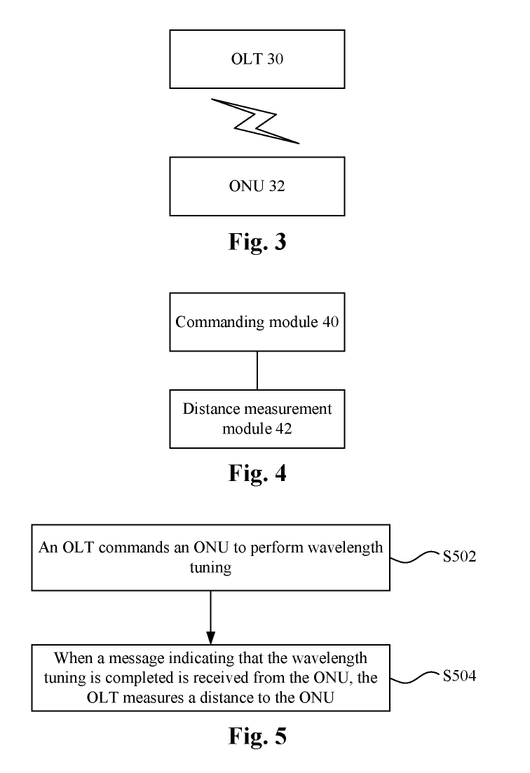

FIG. 3 is a structure diagram of a distance measurement system according to an embodiment of the present disclosure. As shown in FIG. 3, the system includes: an OLT 30 and an ONU 32. The OLT 30 is arranged to send a wavelength tuning command to the ONU 32, and when a message indicating that the wavelength tuning is completed is received from the ONU 32, measure a distance to the ONU 32. The ONU 32 is arranged to, when a wavelength tuning command sent by the OLT 30 is received, perform wavelength tuning, and after the wavelength tuning is completed, send the message indicating that the wavelength tuning is completed to the OLT 30.

In an optional implementation mode of the embodiment of the present disclosure, the OLT 30 may include a device shown in FIG. 4, referring to descriptions made below.

By the system provided by the embodiment of the present disclosure, after the ONU 32 completes wavelength tuning, a distance to the ONU is measured between the OLT 30 and the ONU 32 at the same time of wavelength tuning completion confirmation. By virtue of the technical solution, the problems of system complexity and service interruption caused by additional steps required by distance re-measurement are solved.

According to an embodiment of the present disclosure, a distance measurement device is provided. The distance measurement device may be located in the OLT 30. The distance measurement device may also be independent from the OLT 30 and realize its function through interaction with the OLT 30. There are no specific limits made in the embodiment of the present disclosure.

FIG. 4 is a structure diagram of a distance measurement device according to an embodiment of the present disclosure. As shown in FIG. 4, the device includes: a commanding module 40, arranged to command an ONU to perform wavelength tuning through an OLT; and a distance measurement module 42, arranged to, when the OLT receives a message indicating that the wavelength tuning is completed from the ONU, measure a distance to the ONU.

In an optional implementation mode of the embodiment of the present disclosure, the device may further include: an allocation module, arranged to allocate, to the ONU, an upstream bandwidth used for sending the message indicating that the wavelength tuning is completed; and a receiving module, arranged to receive, within the upstream bandwidth, the message indicating that the wavelength tuning is completed from the ONU.

In an optional implementation mode of the embodiment of the present disclosure, the device may further include: a sending module, arranged to send a confirmation message to the ONU, wherein information carried in the confirmation message includes: confirmation information confirming that the ONU completes the wavelength tuning, and indication information about a distance measurement result obtained by measuring the distance to the ONU.

In an optional implementation mode of the embodiment of the present disclosure, the indication information about the measurement distance result may be indication information about equalization delay adjustment of the ONU. Optionally, the indication information about the equalization delay adjustment of the ONU may include at least one of followings: a new equalization delay value, a difference value between a new equalization delay value and a current equalization delay value of the ONU, and indication information indicating an equalization delay of the ONU not to be adjusted.

According to another embodiment of the present disclosure, an OLT is also provided, which may include the abovementioned distance measurement device.

According to still another embodiment of the present disclosure, a distance measurement method is provided. The method may be implemented by the abovementioned device or system.

FIG. 5 is a flowchart of a distance measurement method according to an embodiment of the present disclosure. As shown in FIG. 5, the method includes the following Step S502-Step S504.

Step S502: an OLT commands an ONU to perform wavelength tuning.

Step S504: when a message indicating that the wavelength tuning is completed is received from the ONU, the OLT measures a distance to the ONU.

In an optional implementation mode of the embodiment of the present disclosure, after the step that the OLT commands the ONU to perform the wavelength tuning, the method may further include the following steps. The OLT allocates, to the ONU, an upstream bandwidth used for sending the message indicating that the wavelength tuning is completed. After the wavelength tuning is completed, the ONU sends, within the upstream bandwidth, the message indicating that the wavelength tuning is completed.

In an optional implementation mode of the embodiment of the present disclosure, after the step that the OLT measures the distance to the ONU, the method may further include the following steps. The OLT sends a confirmation message to the ONU, wherein information carried in the confirmation message includes: confirmation information confirming that the ONU completes the wavelength tuning, and indication information about a distance measurement result obtained by measuring the distance to the ONU.

In an optional implementation mode of the embodiment of the present disclosure, the indication information about the distance measurement result may be indication information about equalization delay adjustment of the ONU. For example, the indication information about the equalization delay adjustment of the ONU may include at least one of followings: a new equalization delay value, a difference value between a new equalization delay value and a current equalization delay value of the ONU, and indication information indicating an equalization delay of the ONU not to be adjusted.

According to the method provided by the embodiment of the present disclosure, after the ONU completes the wavelength tuning, a distance to the ONU is measured between the OLT and the ONU at the same time of wavelength tuning completion confirmation, and the distance measurement result is notified to the ONU. By virtue of the technical solution, the problems of system complexity and service interruption caused by additional steps required by distance re-measurement are solved.

The technical solution provided by the embodiments of the present disclosure will be described below with a specific embodiment.

In an implementation process, a topological structure of a TWDM PON system is shown in FIG. 2. There are multiple TWDM channels in the TWDM system. Each TWDM channel has a TWDM channel terminal of one OLT and a group of corresponding ONUs. Each TWDM channel includes one downstream wavelength channel and one or more upstream wavelength channels. Each TWDM channel terminal manages a group of ONUs. Each group of ONUs is configured to send upstream data with the same upstream wavelength and receive downstream data with the same downstream wavelength. Different ONUs in a group of ONUs transmit upstream data in a time division multiplexing manner. Downstream wavelengths of different TWDM channels are different, and the upstream wavelengths used by each group of ONUs managed by the channel terminals of different OLTs are also different. Each ONU sends the upstream data in a specific upstream timeslot according to commands of the TWDM channel terminals. Each OLT includes one or more TWDM channel terminals.

In order to implement load balancing, energy saving and protection switching, an OLT commands an ONU to change a TWDM channel, that is, the ONU is commanded to perform wavelength tuning. In an implementation process, the OLT and the ONU may implement equalization delay updating after wavelength tuning of the ONU according to the following steps.

Step 1: a TWDM channel terminal 1 on a first TWDM channel commands an ONU with an ONU Identifier (ID) 11 to tune a working wavelength of this ONU to a working wavelength of a second corresponding TWDM channel.

Step 2: after receiving a wavelength tuning message, the ONU with the ONU ID 11 tunes the working wavelength to the working wavelength of the second corresponding TWDM channel.

Step 3: a TWDM channel terminal 2 on the second TWDM channel allocates, to the ONU with the ONU ID 11 by adopting a larger protection time, an upstream bandwidth used for sending a wavelength tuning completion message.

Step 4: the ONU with the ONU ID 11, after receiving on the second TWDM channel the upstream bandwidth allocated to it and used for sending the wavelength tuning completion message, sends the wavelength tuning completion message to the terminal on the second TWDM channel by adopting an equalization delay value allocated on the first TWDM channel.

Step 5: after receiving the wavelength tuning completion message sent by the ONU with the ONU ID 11, the terminal on the second TWDM channel completes distance measurement of the ONU. The terminal on the second TWDM channel sends a distance measurement result to the ONU according to a message shown in FIG. 3(a), FIG. 3(b), FIG. 4(a) or FIG. 4(b).

Step 6: after the ONU receives the distance measurement result sent by the terminal on the second TWDM channel, if it is necessary to update the equalization delay value, the ONU updates a local equalization delay value into the equalization delay value sent by the terminal on the second TWDM channel.

In the implementation process, the message containing the distance measurement result may adopt structures shown in Table 1 to Table 4.

TABLE 1

| Byte | Content | Description |
|---|---|---|
| 1-2 | ONU-ID value of an ONU | Sending to the ONU |
| | | corresponding to the |
| | | ONU-ID value |
| 3 | Message type | |
| 4 | Sequence number | |
| 5-x | TWDM PON channel ID or | |
| | upstream wavelength ID; | |
| | equalization delay value | |
| (x + 1)-40 | Fill | |
| 41-48 | Message Integrity Check (MIC) | MIC |

In Table 1, the content of the first to second bytes is an ONU-ID value of an ONU, and represents that the message is to be sent to the ONU corresponding to the ONU-ID value. The third byte represents a message type of a Physical Layer Operation Administration and Maintenance (PLOAM) message. The fourth byte is a sequence number of the PLOAM message. The content of the fifth to xth bytes is an equalization delay value of the ONU corresponding to a current TWDM channel (or a current upstream wavelength). The content of the (x+1)th to 40th bytes is a fill of the PLOAM message. The content of the 41st to 48th bytes is MIC.

TABLE 2

| Byte | Content | Description |
|---|---|---|
| 1-2 | ONU-ID value of an ONU or | Sending to the ONU or |
| | ONU-ID values to be broadcast | broadcasting to all ONUs |
| 3 | Message type | |
| 4 | Sequence number | |
| 5-x | TWDM PON channel ID or | |
| | upstream wavelength ID; | |
| | equalization delay adjustment | |
| | difference value | |
| (x + 1)-40 | Fill | |
| 41-48 | MIC | MIC |

In Table 2, the content of the first to second bytes is an ONU-ID value of an ONU, and represents that the message is to be sent to the ONU corresponding to the ONU-ID value. The third byte represents a message type of a PLOAM message. The fourth byte is a sequence number of the PLOAM message. The content of the fifth to xth bytes is a equalization delay adjustment difference value of the ONU corresponding to a current TWDM channel (or a current upstream wavelength). The content of the (x+1)th to 40th bytes is a fill of the PLOAM message. The content of the 41st to 48th bytes is MIC.

TABLE 3

| Byte | Content | Description |
|---|---|---|
| 1-2 | ONU-ID value of an ONU or | Sending to the ONU or |
| | ONU-ID values to be broadcast | broadcasting to all ONUs |
| 3 | Message type | |
| 4 | Sequence number | |
| 5 | Confirmation about wavelength | |
| | tuning completion of ONU | |
| 6-x | TWDM PON channel ID or | |
| | upstream wavelength ID; | |
| | equalization delay value | |
| (x + 1)-40 | Fill | |
| 41-48 | MIC | MIC |

In Table 3, the content of the first to second bytes is an ONU-ID value of an ONU, and represents that the message is to be sent to the ONU corresponding to the ONU-ID value. The third byte represents a message type of a PLOAM message. The fourth byte is a sequence number of the PLOAM message. The content of the fifth byte is confirmation about wavelength tuning completion of the ONU. The content of the sixth to xth bytes is an equalization delay value of the ONU corresponding to a current TWDM channel (or a current upstream wavelength). The content of the (x+1)th to 40th bytes is a fill of the PLOAM message. The content of the 41st to 48th bytes is MIC.

TABLE 4

| Byte | Content | Description |
|---|---|---|
| 1-2 | ONU-ID value of an ONU or | Sending to the ONU or |
| | ONU-ID values to be broadcast | broadcasting to all ONUs |
| 3 | Message type | |
| 4 | Sequence number | |
| 5 | Confirmation about wavelength | |
| | tuning completion of ONU | |
| 6-x | TWDM PON channel ID or | |
| | upstream wavelength ID; | |
| | equalization delay adjustment | |
| | difference value | |
| (x + 1)-40 | Fill | |
| 41-48 | MIC | MIC |

In Table 4, the content of the first to second bytes is an ONU-ID value of an ONU, and represents that the message is to be sent to the ONU corresponding to the ONU-ID value. The third byte represents a message type of a PLOAM message. The fourth byte is a sequence number of the PLOAM message. The content of the fifth byte is confirmation about wavelength tuning completion of the ONU. The content of the sixth to xth bytes is a equalization delay adjustment difference value of the ONU corresponding to a current TWDM channel (or a current upstream wavelength). The content of the (x+1)th to 40th bytes is a fill of the PLOAM message. The content of the 41st to 48th bytes is MIC.

The equalization delay value or equalization delay adjustment difference value in the message shown in Table 1, Table 2, Table 3 or Table 4 is 0, which represents that the ONU is not required to change the local equalization delay value.

From the above, it can be seen that in the embodiment of the present disclosure, after the ONU completes the wavelength tuning, a distance to the ONU is measured between the OLT and the ONU at the same time of wavelength tuning completion confirmation, and the distance measurement result is notified to the ONU. By virtue of the technical solution, the problems of system complexity and service interruption caused by additional steps required by distance re-measurement are solved.

Industrial practicability: from the descriptions in the embodiments and exemplary embodiments of the present disclosure, it can be seen that the solutions of the embodiments of the present disclosure can reduce a complexity in a requirement of wavelength tuning of the ONU in a TWDM PON system on distance re-measurement, improve upstream transmission efficiency, and improve quality of service of a network.

Obviously, those skilled in the art should know that each module or each step of the present disclosure may be implemented by a universal computing device, and the modules or steps may be concentrated on a single computing device or distributed on a network formed by a plurality of computing devices, and may optionally be implemented by program codes executable for the computing devices, so that the modules or steps may be stored in a storage device for execution with the computing devices, the shown or described steps may be executed in sequences different from those described here in some circumstances, or may form each integrated circuit module respectively, or multiple modules or steps therein may form a single integrated circuit module for implementation. As a consequence, the present disclosure is not limited to any specific hardware and software combination.

The above is only the exemplary embodiment of the present disclosure and not intended to limit the present disclosure, and for those skilled in the art, the present disclosure may have various modifications and variations. Any modifications, equivalent replacements, improvements and the like within the principle of the present disclosure shall fall within the scope of protection defined by the appended claims of the present disclosure.

1. A distance measurement method, comprising:
commanding, by an Optical Line Terminal (OLT), an Optical Network Unit (ONU) to perform wavelength tuning; and
when a message indicating that the wavelength tuning is completed is received from the ONU, measuring, by the OLT, a distance to the ONU.

2. The method as claimed in claim 1, after commanding, by the OLT, the ONU to perform wavelength tuning, further comprising:
allocating, by the OLT to the ONU, an upstream bandwidth used for sending the message indicating that the wavelength tuning is completed; and
after the wavelength tuning is completed, sending, by the ONU, within the upstream bandwidth the message indicating that the wavelength tuning is completed.

3. The method as claimed in claim 1, after measuring, by the OLT, the distance to the ONU, further comprising:
sending, by the OLT, a confirmation message to the ONU, wherein information carried in the confirmation message comprises: confirmation information confirming that the ONU completes the wavelength tuning, and indication information about a distance measurement result obtained by measuring the distance to the ONU.

4. The method as claimed in claim 3, wherein the indication information about the distance measurement result is indication information about equalization delay adjustment of the ONU.

5. The method as claimed in claim 4, wherein the indication information about the equalization delay adjustment of the ONU comprises at least one of followings: a new equalization delay value, a difference value between a new equalization delay value and a current equalization delay value of the ONU, and indication information indicating an equalization delay of the ONU not to be adjusted.

6. A distance measurement device, comprising a hardware processor arranged to execute the following program modules:
a commanding module, arranged to command, through an Optical Line Terminal (OLT), an Optical Network Unit (ONU) to perform wavelength tuning; and
a distance measurement module, arranged to, when the OLT receives a message indicating that the wavelength tuning is completed from the ONU, measure a distance to the ONU.

7. The device as claimed in claim 6, the hardware processor is further arranged to execute the following program modules:
an allocation module, arranged to allocate, to the ONU, an upstream bandwidth used for sending the message indicating that the wavelength tuning is completed; and
a receiving module, arranged to receive, within the upstream bandwidth, the message indicating that the wavelength tuning is completed from the ONU.

8. The device as claimed in claim 5, the hardware processor is arranged to execute the following program module:
a sending module, arranged to send a confirmation message to the ONU, wherein information carried in the confirmation message comprises: confirmation information confirming that the ONU completes the wavelength tuning, and indication information about a distance measurement result obtained by measuring the distance to the ONU.

9. An Optical Line Terminal (OLT), comprising the distance measurement device as claimed in claims 6.

10. A distance measurement system, comprising: an Optical Network Unit (ONU) and the Optical Line Terminal (OLT) as claimed in claim 9, wherein the ONU is arranged to, when a wavelength tuning command is received from the OLT, perform wavelength tuning according to the wavelength tuning command, and when the wavelength tuning is completed, send a message indicating that the wavelength tuning is completed to the OLT.

11. The device as claimed in claim 8, wherein the indication information about the distance measurement result is indication information about equalization delay adjustment of the ONU.

12. The device as claimed in claim 11, wherein the indication information about the equalization delay adjustment of the ONU comprises at least one of followings: a new equalization delay value, a difference value between a new equalization delay value and a current equalization delay value of the ONU, and indication information indicating an equalization delay of the ONU not to be adjusted.

13. An Optical Line Terminal (OLT), comprising the distance measurement device as claimed in claim 7.

14. An Optical Line Terminal (OLT), comprising the distance measurement device as claimed in claim 8.

15. An Optical Line Terminal (OLT), comprising the distance measurement device as claimed in claim 11.

16. An Optical Line Terminal (OLT), comprising the distance measurement device as claimed in claim 12.

17. A distance measurement system, comprising: an Optical Network Unit (ONU) and the Optical Line Terminal (OLT) as claimed in claim 13, wherein the ONU is arranged to, when a wavelength tuning command is received from the OLT, perform wavelength tuning according to the wavelength tuning command, and when the wavelength tuning is completed, send a message indicating that the wavelength tuning is completed to the OLT.

18. A distance measurement system, comprising: an Optical Network Unit (ONU) and the Optical Line Terminal (OLT) as claimed in claim 14, wherein the ONU is arranged to, when a wavelength tuning command is received from the OLT, perform wavelength tuning according to the wavelength tuning command, and when the wavelength tuning is completed, send a message indicating that the wavelength tuning is completed to the OLT.

19. A distance measurement system, comprising: an Optical Network Unit (ONU) and the Optical Line Terminal (OLT) as claimed in claim 15, wherein the ONU is arranged to, when a wavelength tuning command is received from the OLT, perform wavelength tuning according to the wavelength tuning command, and when the wavelength tuning is completed, send a message indicating that the wavelength tuning is completed to the OLT.

20. A distance measurement system, comprising: an Optical Network Unit (ONU) and the Optical Line Terminal (OLT) as claimed in claim 16, wherein the ONU is arranged to, when a wavelength tuning command is received from the OLT, perform wavelength tuning according to the wavelength tuning command, and when the wavelength tuning is completed, send a message indicating that the wavelength tuning is completed to the OLT.
